(19) United States
(12) Patent Application Publication
(10) Pub. No.: US 2016/0196739 A1
(43) Pub. Date: Jul. 7, 2016

(54) WIRELESS THERMOMETER COMMUNICATING WITH COOKTOP FOR CLOSED LOOP ELEMENT CONTROL

(71) Applicant: General Electric Company, Schenectady, NY (US)

(72) Inventors: Christopher Nils Naber, Louisville, KY (US); Jeffrey Lynn Jessie, Taylorsville, KY (US)

(21) Appl. No.: 14/591,255

(22) Filed: Jan. 7, 2015

(51) Int. Cl. G08C 17/02

(52) U.S. Cl. CPC G08C 17/02; G08C 2201/42

(57) ABSTRACT

Methods, devices and systems are provided that enable closed loop control of a cooking appliance. A remote device is configured to receive cooking environment data related such as cooking temperature and to transmit that data to a smart device such as a smartphone. The smart device contains a program permitting user data entry for selecting cooking programs and for processing received cooking environment data in accordance with the contained program. The smart device may then transmit control instructions to the cooking appliance to enable closed loop control thereof.

### FIELD OF THE INVENTION

The present subject matter relates to cooktop appliances. More particularly, the present subject matter relates to systems and methods for communicating data from a wireless thermometer to a cooktop as a part of a closed loop element control.

### BACKGROUND OF THE INVENTION

Recently interest has been increasing in the development of remote operation of home appliances. With respect to individuals, particularly home owners, interest has developed regarding Internet, or at least home network, connected appliances, for example refrigerators, ovens, cooktops, laundry machines, and others.

As appliances are connected to consumer's home networks, opportunities have become available to implement features for such appliances that were not necessarily available at the time of manufacture of a particular appliance or were available for only high end models at increased cost to the consumer.

A common example of this situation resides in the known provision of temperature probes in ovens that may be temporarily inserted into an item being cooked and removed altogether by disconnection of the temperature probe when not in use. Such temperature probe configurations do provide some additional convenience to the consumer but also have their own limitations and disadvantages. One such disadvantage is the additional cost of providing the circuitry within the oven at time of manufacture. Another disadvantage resides in the fact that only temperature was monitored and no additional adjustments could be made to a cooking program by the consumer.

In light of these disadvantages, it would be desirable to provide control devices that may be used with appliances that require no additional components to be added to the appliance. Further it would be desirable if there were a mechanism that would provide the consumer with enhanced operational control of the appliance without requiring that modifications be made to the appliance or the appliance's own on board user interface (UI).

### BRIEF DESCRIPTION OF THE INVENTION

Aspects and advantages of the invention will be set forth in part in the following description, or may be obvious from the description, or may be learned through practice of the invention.

The present subject matter relates to a system for wireless closed loop control of a cooking appliance. Such system includes a cooking appliance having a control system, at least one cooking environment condition responsive probe, a first transmitter/receiver configured to transmit data from the at least one probe, a second transmitter/receiver coupled to the control system, and a smart device. In certain embodiments of the system the smart device is configured for communications with the first transmitter/receiver and the second transmitter/receiver and contains a user configurable application for controlling cooking parameters of the cooking appliance based at least in part on data from the at least one probe.

The preset subject matter also relates to a system for enabling wireless closed loop control of a cooking appliance. Such system includes at least one cooking environment condition responsive probe and a housing, a communications board mounted within the housing and configured to wirelessly transmit data from the at least one probe, and an input/output board mounted on the housing and configured to display data from the at least one probe.

Further, the present subject matter as relates to a method for enabling wireless closed loop control of a cooking appliance. According to such method data related to at least one cooking environment condition is collected and then communicated to a smart device remote from the cooking environment. The method provides for processing the data within the smart device and then controlling the cooking environment condition based on the processed data.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides an overview of a cooktop system constructed in accordance with the present subject matter;

FIG. 2 provides a more detailed block diagram of a remote device constructed in accordance with the present subject matter;

FIG. 3 provides a more detailed block diagram of an exemplary communications arrangement for a cooktop for use with the present subject matter; and

FIG. 4 is a flow chart illustrating an exemplary method for enabling closed loop control of a cooking appliance in accordance with the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present subject matter is directed to a system and method for providing closed loop cooktop control primarily, but not exclusively, as an aftermarket feature for existing cooktops.

It should be appreciated that while the present disclosure generally makes reference to the use of a smart device, such smart device is intended to correspond to any device that may be programmed to communicate at least with another device using one of WiFi, Bluetooth®, ZigBee®, or similar type communications technologies while running a program that provides for user input. In this context, devices such as, but not limited to, smartphones, tablet devices, and standalone devices may be used to implement the present subject matter.

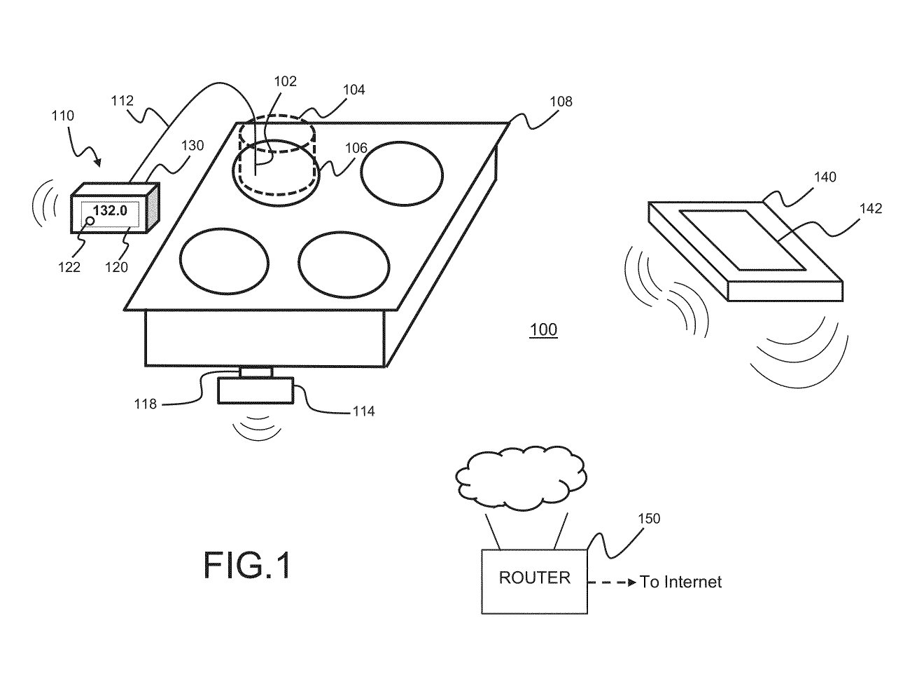

Referring more particularly to the presently disclosed subject matter and with reference to FIG. 1 there is provided an overview of a cooktop system 100 constructed in accordance with the present subject matter. In accordance with an exemplary configuration, a temperature probe 102 may be inserted into the food or liquid contained in a cooking vessel 104 placed on a burner 106 of a cooktop 108.

It should be appreciated that while the present description will generally be limited to discussion of the use of a temperature probe, it is envisioned that other types or combinations of probes may be used in the context of the present subject matter. For example, in certain embodiments, the present subject matter may provide for the use of a temperature and/or pressure sensitive probe. In still other embodiments, the present subject matter also envisions the use of probes that would react to other cooking environment conditions, such as, but not limited to, viscosity or moisture. Further still, other embodiments of the present subject matter may employ a combination of several sensors wherein data from each sensor is made available for use by the system.

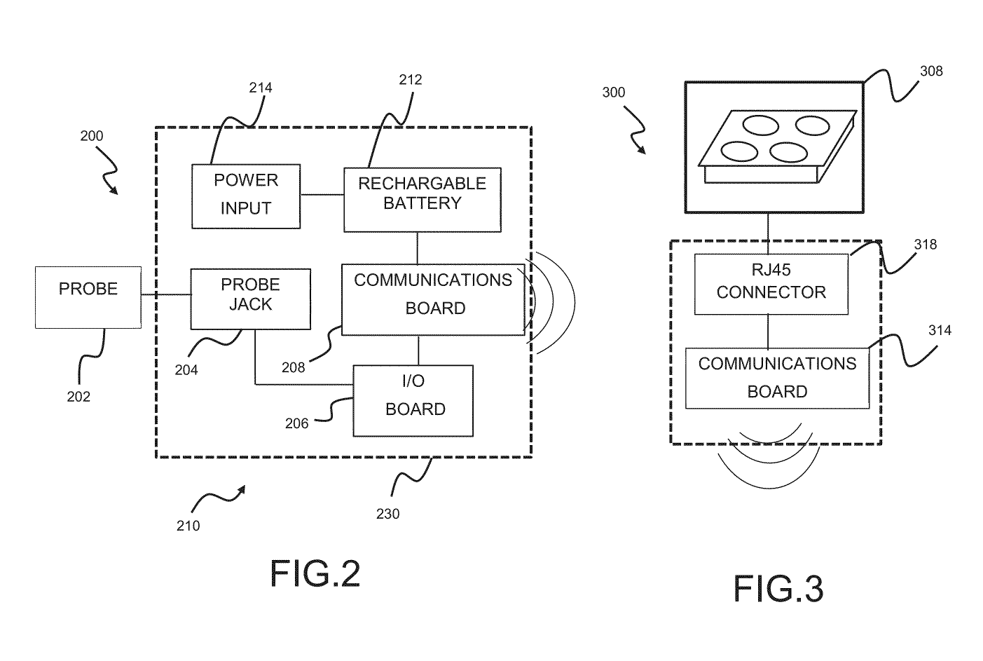

With continued reference to FIG. 1, a wireless transmitter/receiver 110 is connected to temperature probe 102 via cable 112 and is configured to transmit temperature data received from probe 102. Wireless transmitter/receiver 110 may incorporate a display panel 120 on which temperature indications may be displayed. Display panel 120 may be a touch panel type display and as such may incorporate portions such as touch area 122 that are designed to toggle display panel 120 to an input screen configuration allowing user input to wireless transmitter/receiver 110. The various components of wireless transmitter/receiver 110, to be described more fully later with respect to FIG. 2, may be contained in a housing 130. A wireless transmitter/receiver 114 is connected to the cooktop's control system (not separately illustrated) by way of a connector 118.

Further in accordance with the present subject matter, a smart device 140 is provided that contains a user configurable application for controlling various cooking parameters including, without limitation, time, temperature, and alerts for a desired cooking activity. It should be appreciated that smart device 140 may correspond to a smartphone, a tablet device, a personal computer (PC), a stand-alone device, or any such similar device capable of running a cooking control program and communicating wirelessly with other devices.

In accordance with the present subject matter, a receiver associated with smart device 140 is configured to gather temperature data from probe 102 via transmitter/receiver 110, as well as the user defined settings from the application running on smart device 140. Transmitter/receiver 114 also receives data from probe 102 as well as data from smart device 140. User information may be entered using a touch screen 142 on smart device 140 or by other suitable means. The gathered and entered data is then communicated to the cooktop 108 control system where it is processed to adjust or control burner 106 accordingly to maintain or produce a desire condition. All information including probe data and/or appliance control settings and commands may be made available to smart device 140 so that such information and data may be monitored by the user.

In accordance with the present subject matter, cooktop 108 may correspond to a device incorporating a control system employing category 5 (CAT 5) type communications technology such as, for example, a General Electric Model No. PP945BMBB cooktop. While the present disclosure is generally directed to the use of WiFi communications technology, those of ordinary skill in the art will appreciate that other systems and communications technologies may also be employed. For example Bluetooth® or ZigBee® systems could also be employed with the present technology. Regardless of the type of communications technology used, the cooktop, such as the one mentioned above, should have an accessible control system with which the devices herein described may communicate.

With further reference to FIG. 1, it should be appreciated that while the previous discussion has described communication among smart device 140, transmitter/receiver 110, and transmitter/receiver 114, it should be appreciated that such communications may be performed directly between these devices or indirectly by way of a home router 150. Further still, it should be appreciated that router 150 optionally may also be couple to the Internet whereby smart device 140 may communicate with transmitter/receiver 110 and/or transmitter/receiver 114 from remote locations via the Internet.

With reference to FIG. 2 there is illustrated a more detailed block diagram 200 of a transmitter/receiver 210 (illustrated as transmitter/receiver 110 in FIG. 1) in accordance with the present subject matter. As illustrated in FIG. 2, a probe 202 may be connected by way of a jack 204 to an input/output (I/O) board 206 which, in turn, is connected to a communications board 208, both of which are mounted within housing 230 and configured to provide WiFi communications among wireless transmitter/receivers 114, smart device 140, and/or router 150. Jack 204 may be mounted to housing 230 to enable disconnection, replacement, or substitution of probe 202. In an alternate configuration, probe 202 may be wired directly to I/O board 206. Input/out (I/O) board 206 may also include a display screen such as display 120 (FIG. 1) to display temperature readings or other indications as well as providing user input capabilities such as the previously mentioned touch input capability of display 120. I/O board 206 may be mounted to an external surface of housing 230. It should be appreciated that additional user input devices including without limitation, keyboards, button, and switches may be coupled to I/O board 206 as desired for particular embodiments of the present subject matter.

Lastly, the various components of transmitter/receiver 210 may receive operating power from rechargeable battery 212 which itself may receive energy from a power input 214 configured to receive energy from, for example, a home power outlet. It should be appreciated that other power supply configurations may be provided including, without limitation, non-rechargeable batteries and home power outlet energized power supplies.

With reference to FIG. 3 there is provided a more detailed block diagram 300 of an exemplary communications arrangement for a cooktop 308 for use with the present subject matter. As illustrated a connector 318 may be associated with cooktop 308 and designed to be coupled to a communications board 314. Communications board 314 is configured to provide transmission and reception of signals based on a desired communications technology and to communicate signals to and/or from a control system incorporated into cooktop 308. As generally discussed here, such communications technology corresponds to WiFi technology, however, as already mentioned, other technologies may be employed as the present subject matter is not dependent on any one technology.

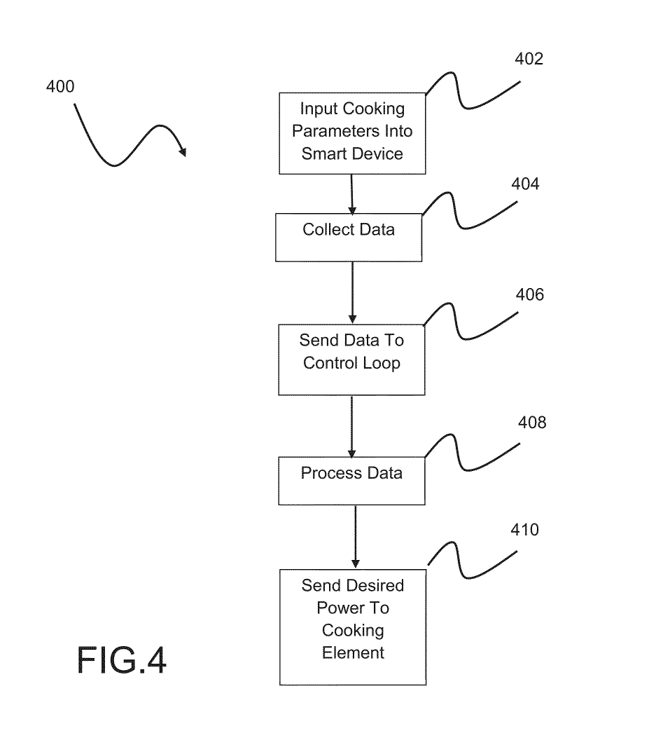

With reference to FIG. 4, there is illustrated a flow chart 400 illustrating an exemplary method for enabling closed loop control of a cooking appliance in accordance with the present subject matter. In accordance with such method at step 402 cooking parameters are entered into the smart device 140. Such cooking parameters may include, but are not limited to, cooking times, cooking duration, and cooking temperature(s). At step 404 data related to at least one cooking environment condition is collected. As previously noted such data may relate to one or more of temperature, pressure, viscosity, and moisture and may be collected using one or more condition responsive probes. Next at step 406 the collected data is sent to the cooking appliance control loop. Such data may also be sent to the smart device. In some embodiments the smart device may correspond to a smartphone, a personal computer, a tablet device or a standalone device. Regardless of the type of smart device used to perform the method, the smart device will contain a program to process data including consumer entered instructions and optionally collected data so that such data may be forwarded to appliance control loop per step 406. Thereafter at step 408 the entered and collected data is processed within the appliance control loop. Finally at step 410 the control loop within the appliance will send instructions to the appliance cooking element for controlling the cooking environment condition based on the processed data.

By employing the technology of the present subject matter a user may enable a “plug-and play” closed loop cooktop control as an aftermarket feature for an existing cooktop. By providing a sensor to communicate data (i.e. pressure, temperature, etc.) to the cooktop and/or smart device, the system enables a desired action as a function of the conditions of the item on the burner. That is, the system of the present subject matter provides a closed loop burner control. The uses of such system could include a large variety of cooking programs depending on the type and number of sensors provided including, for example and without limitation: Sous Vide cooking, alerting the cook when a temperature has been achieved, limiting power output of the burner to maintain desired temperature (boiling etc), tempering chocolate, candy making, and heating soups to a desire temperature.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for wireless closed loop control of a cooking appliance, comprising:
a cooking appliance having a control system;
at least one cooking environment condition responsive probe;
a first transmitter/receiver configured to transmit data from said at least one probe;
a second transmitter/receiver coupled to said control system; and
a smart device,
wherein said smart device is configured for communications with said first transmitter/receiver and said second transmitter/receiver, and
wherein said smart device contains a user configurable application for controlling cooking parameters of said cooking appliance based at least in part on data from said at least one probe.

2. A system as in claim 1, further comprising:
a router configured for communications among said first transmitter/receiver, said second transmitter/receiver, and said smart device.

3. A system as in claim 2, wherein said router is configured for connection to the Internet.

4. A system as in claim 3, wherein said smart device is enabled for communication over the Internet.

5. A system as in claim 1, wherein said first transmitter/receiver, said second transmitter/receiver, and said smart device are configured for communications using one of WiFi, Bluetooth®, and ZigBee® technology.

6. A system as in claim 1, wherein said at least one cooking environment condition responsive probe is responsive to one or more of temperature, pressure, viscosity, and moisture.

7. A system as in claim 1, wherein said smart device comprises one of a smartphone, a tablet device, a personal computer, and a standalone device.

8. A system as in claim 1, further comprising:
a connector coupled to said cooking appliance control system,
whereby said second transmitter/receiver may be coupled to said control system.

9. A system as in claim 8, wherein said connector is an RJ45 connector.

10. A system for enabling wireless closed loop control of a cooking appliance, comprising:
at least one cooking environment condition responsive probe;
a housing;
a communications board mounted within said housing and configured to wirelessly transmit data from said at least one probe; and
an input/output board mounted on said housing and configured to display data from said at least one probe.

11. A system as in claim 10, wherein said at least one cooking environment condition responsive probe is responsive to one or more of temperature, pressure, viscosity, and moisture.

12. A system as in claim 10, further comprising:
a jack mounted to said housing and configured to receive signals from said at least one cooking environment condition responsive probe and to convey said signals to said communications board.

13. A system as in claim 10, wherein said display is a touch responsive display, whereby user input may be entered through said input/output board.

14. A system as in claim 10, further comprising:
a power supply mounted within said housing.

15. A system as in claim 14, wherein said power supply is a battery.

16. A system as in claim 15, wherein said battery is a rechargeable battery.

17. A system as in claim 10, wherein said communications board is configured for communications using one of WiFi, Bluetooth®, and ZigBee® technology.

18. A method for implementing closed loop control of a cooking appliance, comprising:
collecting data related to at least one cooking environment condition;
communicating the data to a smart device remote from the cooking environment;
processing the data within the smart device; and
controlling the cooking environment condition based on the processed data.

19. The method of claim 18, wherein communicating comprises wirelessly transmitting one of WiFi, Bluetooth®, and ZigBee® protocols.

20. The method of claim 18 wherein collecting comprises collecting one or more of temperature, pressure, viscosity, and moisture cooking environment data.
